(19) United States
(12) Patent Application Publication
(10) Pub. No.: US 2007/0054081 A1
(43) Pub. Date: Mar. 8, 2007

(54) Double-Sided Adhesive Anchoring Device For A Garment

(76) Inventor: Jill R. DeMarco, Arnold, MD (US)

Correspondence Address: MEDLER FERRO PLLC, 8607 ROCKDALE LANE, SPRINGFIELD, VA, 22153, US

(21) Appl. No.: 11/465,573

(22) Filed: Aug. 18, 2006

Related U.S. Application Data
(60) Provisional application No. 60/711,038, filed on Aug. 18, 2005.

(51) Int. Cl. B32B 33/00

(52) U.S. Cl. 428/40.1

(57) ABSTRACT

An anchoring device for temporarily adhering a portion of a garment to a wearer. The anchoring device includes a fabric substrate having a first surface and a second surface with a first adhesive disposed on the first surface and a second adhesive disposed on the second surface. The first adhesive being used to adhere the anchoring device to the garment and the second adhesive being used to adhere the anchoring device to the skin of the wearer. The garment anchoring device may be disposed along an inside edge of the fabric of a garment, such as, along a neckline of a blouse, bathing top or dress, to hold the item against the wearer. As well, the garment anchoring device may be used along an edge of a leg hole of an underpant or swimsuit bottom to anchor the item to the wearer's buttocks and thereby prevent the underpant or swimsuit bottom from riding-up on the wearer.

### CROSS-REFERENCE TO RELATED APPLICATION

This application claims the benefit of U.S. Provisional Application No. 60/711,038 filed Aug. 18, 2005, which is incorporated by reference herein in its entirety.

### FIELD OF THE INVENTION

The present invention relates to an anchoring device for apparel to be worn by a female, and more particularly, to a double-sided adhesive anchoring device that can be attached between a garment and a wearer to maintain the garment in place against a wearer's skin.

### BACKGROUND OF THE INVENTION

In many of today's fashions for women, the clothing seemingly is required to defy the laws of gravity and/or the natural curvature of the female form in order to appropriately and tastefully cover the wearer. Women's fashions, such as, low-cut, halter, backless, and/or strapless tops and dresses, routinely gap from or slip on the wearer, which may result in exposure of an undergarment and/or, in the worst case, the breasts of the wearer. Another problem area for a woman is a garment that “rides-up” and becomes uncomfortable and/or unsightly during normal wear, such as bathing suit bottoms or underpants that do not stay in place over the wearer's buttocks. The woman wearing such garments may need to routinely pull-up, pull-down and/or straighten the garment, which can be an annoyance to her and unattractive to those about her.

To address this problem, anti-slip mechanisms have been suggested that attempt to prevent undesirable movement of a garment by frictionally engaging the wearer. However, these devices tend to undesirably pinch and/or rub against the wearer causing discomfort and do not always provide the desired result. Fashion tape and spray adhesives are also known as a quick fix to address certain of these problems, but often do not stick well to the wearer and/or the fabric, may cause damage to the fabric upon removal and/or laundering, and require replacement/reapplication after each use.

Accordingly, there is a need for a durable garment anchoring device that can be attached to a garment and to a wearer's body to maintain the placement of the garment against the wearer's body that overcomes one or more of the foregoing deficiencies.

### BRIEF SUMMARY OF THE INVENTION

An anchoring device for temporarily adhering a portion of a garment to a wearer. The anchoring device includes a fabric substrate having a first surface and a second surface with a first adhesive disposed on the first surface and a second adhesive disposed on the second surface. The first adhesive may be a semi-permanent fabric adhesive to adhere the anchoring device to the material of the garment and the second adhesive may be a temporary body/skin adhesive to adhere the anchoring device to the skin of the wearer. In an embodiment, the garment anchoring device may be disposed along an inside edge of the fabric of a garment, such as, along a neckline of a blouse, top or dress, to hold the item against the wearer. In another embodiment, the garment anchoring device may be used along an edge of a leg hole of an underpant or swimsuit bottom to anchor the item to the wearer's buttocks and thereby prevent the underpant or swimsuit bottom from riding-up on the wearer.

### BRIEF DESCRIPTION OF DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIGS. 1-3 illustrate a planar view of various garment anchoring devices in accordance with embodiments of the present invention.

FIG. 1A illustrates a side view of the garment anchoring device shown in FIG. 1.

FIG. 3A illustrates a cross-sectional view of the garment anchoring device shown in FIG. 3.

FIG. 4 illustrates a front view of a garment having the garment anchoring device shown in FIG. 1 attached thereto in accordance with another embodiment of the present invention.

FIG. 5 illustrates a back view of a garment having the garment anchoring device shown in FIG. 2 attached thereto in accordance with another embodiment of the present invention.

FIG. 6 illustrates a back view of a bathing garment having the garment anchoring device shown in FIG. 3 attached thereto in accordance with another embodiment of the present invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

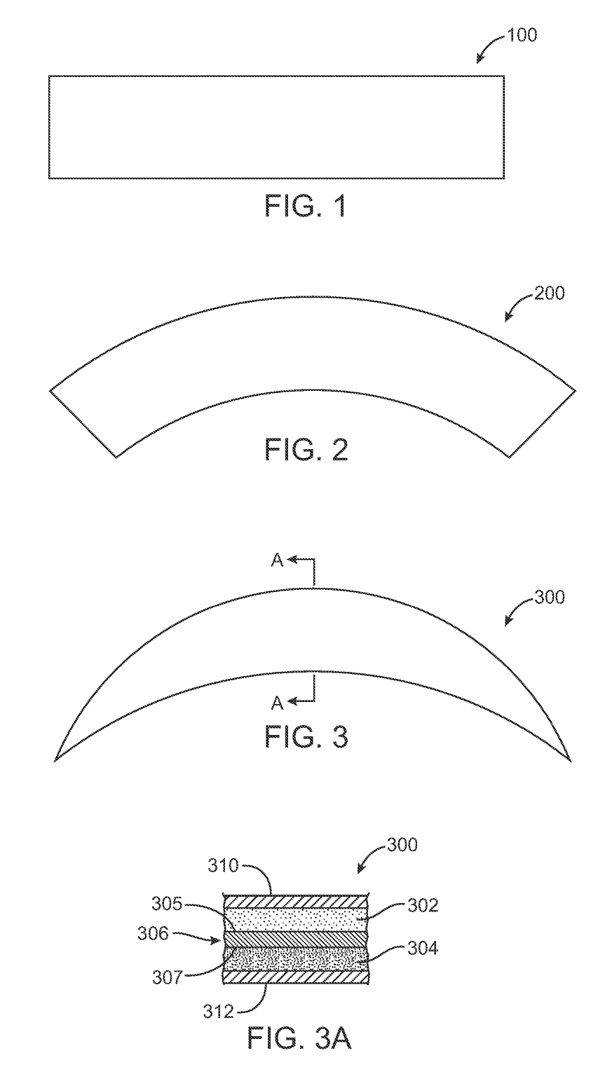

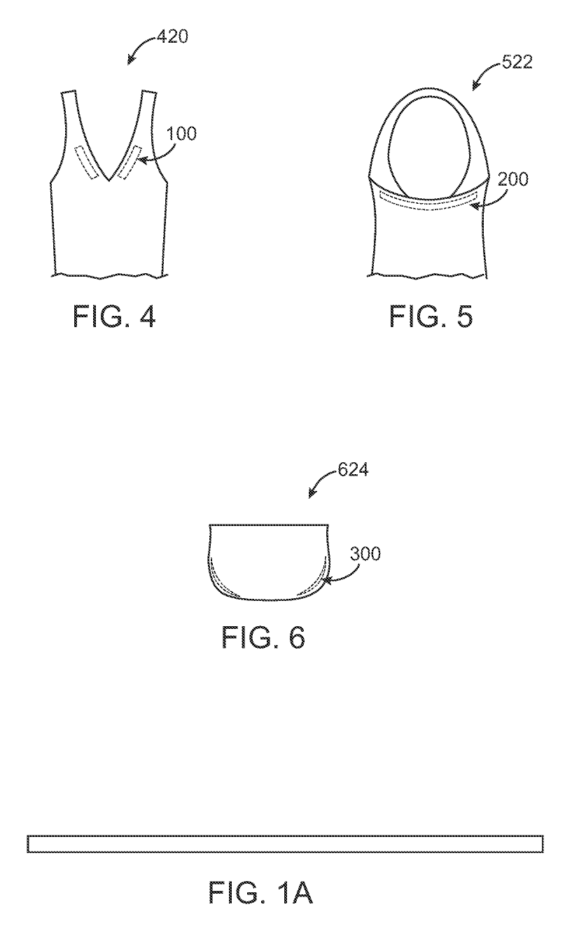

FIGS. 1 and 1A illustrate a garment anchoring device 100 in accordance with an embodiment of the present invention. Garment anchoring device 100 is a rectangular strip and may be of any length or width that is suitable for securing a garment edge on which it will be utilized to a wearer's skin. As shown in FIG. 1A, garment anchoring device 100 has a thin profile, or depth, so as to be inconspicuous when affixed to an inside of a garment. FIGS. 2-3 illustrate a curved garment anchoring device 200 and a crescent-shaped garment anchoring device 300, respectively, that are shaped for various garment applications in accordance with embodiments of the present invention. Garment anchoring devices 200, 300 may be of any length or width dimensions that are suitable for securing a garment edge on which each will be placed to a wearer's skin. As with the embodiment of FIGS. 1 and 1A, each of garment anchoring devices 200, 300 has a thin profile, or depth, so as to be inconspicuous when affixed to an inside of a garment. It should be understood by one of ordinary skill in the art that the shapes disclosed in FIGS. 1-3 are exemplary only and that a garment anchoring device may be of another shape, for example, trapezoidal, circular, semi-circular, and triangular, and/or may be provided in a rectangular or circular sheet for cutting to any desired shape or size without departing from the scope of the present invention.

FIG. 3A illustrates a cross-sectional view of the garment anchoring device 300 shown in FIG. 3. Garment anchoring device 300 includes a flexible, resilient fabric substrate 306 with a garment side 305 and a wearer side 307. Fabric substrate 306 provides stability to garment anchoring device 300, such that when device 300 is applied to a garment it acts as a fabric liner to provide support and shape to the garment. In various embodiments, a pliable material made by weaving, felting, or knitting natural or synthetic fibers and filaments, i.e., a cloth fabric, may be used for fabric substrate 306. In another embodiment, fabric substrate 306 may be made from a knit cloth of a polyester blend, such as a polyester/lycra or a polyester/nylon blend.

A fabric adhesive 302 is disposed on garment side 305 of fabric substrate 306 and a body or skin adhesive 304 is disposed on wearer side 307 of fabric substrate 306. In an embodiment, fabric adhesive 302 is a semi-permanent acrylic-based adhesive for attaching garment anchoring device 300 to the fabric of a garment for several wearings. The semi-permanent adhesive may be a removable, repositionable adhesive, as one of those available, inter alia, through the 3M corporation of St. Paul, Minn.

Body or skin adhesive 304 may be readily detached from a wearer's skin without the use of solvents and is reusable for attaching garment anchoring device 300 to the wearer's skin upon the next wearing of the garment. A body or skin adhesive according to embodiments of the present invention should be capable of adhering to that part of the body to which it is to be attached and to the fabric substrate 306. In an embodiment, the body or skin adhesive will be a pressure sensitive adhesive, which is intended to mean an adhesive that is inherently tacky, visco-elastic and cohesive in its normal dry state. In an embodiment, body adhesive 304 may be a thermoplastic polyurethane (TPU) silicone based skin adhesive for temporarily securing garment anchoring device 300 to a wearer. In various other embodiments, body or skin adhesive 304 may be a medical grade, pressure-sensitive adhesive, such as a medical adhesive of acrylate ester/vinyl pyrrolidone copolymers, dimethyl silicone polymers, or acrylate polymers. Such medical grade skin adhesives have a low level of allergenicity, i.e., are nonirritating to the skin, and have good water resistance to continue to adhere when the skin perspires. In addition, suitable medical grade skin adhesives may possess sufficiently high cohesive strength to allow clean removal of the adhesive from skin and other properties that allow it to accommodate skin movement without losing the bond and without excessive skin irritation.

In another embodiment, fabric and body adhesives 302, 304 may be waterproof to continue to secure garment anchoring device 300 to the garment and wearer even when the garment is wet. Waterproof or water impermeable adhesives suitable for use in the present invention may include natural rubber latex based adhesives, synthetic rubber based adhesives and hot-melt adhesives.

In an embodiment, fabric adhesive 302 and body adhesive 304 may be protected by removable cover layers 310, 312 prior to use. As shown in FIG. 3A, cover layer 310 is of a coated paper material and cover layer 312 is of a reusable, transparent plastic material to enable a user to distinguish between the garment side 305 and the wearer side 307 of garment anchoring device 300. In addition, cover layer 312 is constructed to allow for its placement on body adhesive 304 of garment anchoring device 302 between uses. In another embodiment, cover layers 310, 312 may be of the same material but printed with appropriate verbiage for distinguishing the garment and wearer sides of the garment anchoring device.

FIGS. 4-6 illustrate, by way of example and not limitation, placement of garment anchoring devices 100, 200 and 300 on various items of clothing. In FIG. 4, garment anchoring device 100 is attached along an inside, front edge of a woman's top 420 for securing the top to the wearer's chest. In FIG. 5, garment anchoring device 200 is attached along an inside, upper edge of the back of a woman's halter top 522 for securing the top to the wearer's back. In FIG. 6, garment anchoring device 300 is attached along an inside edge of the leg openings of a woman's swimsuit bottom 624 for securing the swimsuit bottom to the wearer's buttocks. In another embodiment, a garment anchoring device according to the present invention may be used to adhere a bathing garment top, such as a bikini top, to a wearer without the use of additional securing/attachment means to minimize tan lines.

In use, cover layer 310 is removed from fabric adhesive 302 on the garment side 305 of garment anchoring device 300. Garment side 305 is then attached to an inside edge of an article of clothing, for example, the leg openings of bathing suit bottom 624 as shown in FIG. 6. Cover layer 312 is removed from body adhesive 304 on the wearer side 307 of garment anchoring device 300. Wearer side 307 is then attached to a wearer's skin to secure the article of clothing thereto, for example, attached to the skin of the wearer's buttocks for securing bathing suit bottom 624. Once the wearer wishes to remove the article of clothing, body adhesive 304 on wearer side 307 of garment anchoring device 300 may be detached from the wearer by pulling garment anchoring device 300 away from the wearer's skin. Semi-permanent fabric adhesive 302 allows garment anchoring device 300 to remain attached to the article of clothing through several wearings and/or peeled-off the clothing by the wearer when desired. Wearer side 307 of garment anchoring device 300 may be covered between uses by a paper or TPU backing to aid in preserving body or skin adhesive 304 thereon until the next wearing.

While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. An anchoring device for temporary adherence of an edge of a garment to a wearer, the anchoring device comprising:
a fabric substrate having a garment side and a wearer side;
a first adhesive disposed on the garment side of the fabric substrate; and
a second adhesive different from the first adhesive disposed on the wearer side of the fabric substrate, wherein the first adhesive is for adhering the anchoring device to the garment and the second adhesive is for adhering the anchoring device to the skin of the wearer.

2. The anchoring device of claim 1, wherein the first adhesive is a semi-permanent fabric adhesive.

3. The anchoring device of claim 2, wherein the fabric adhesive is a repositionable adhesive.

4. The anchoring device of claim 2, wherein the second adhesive is a reusable, temporary body adhesive.

5. The anchoring device of claim 4, wherein the body adhesive is a thermoplastic polyurethane silicone based adhesive.

6. The anchoring device of claim 4, wherein the fabric substrate is comprised of a knit cloth of a polyester blend.

7. The anchoring device of claim 1, wherein the fabric substrate is crescent-shaped.

8. A garment anchoring device comprising:
a cloth fabric substrate having a garment side and a wearer side;
a fabric adhesive disposed on the garment side of the fabric substrate; and
a skin adhesive disposed on the wearer side of the fabric substrate, wherein the fabric adhesive is for adhering the anchoring device to a garment and the skin adhesive is for adhering the anchoring device to the skin of a wearer.

9. The anchoring device of claim 8, wherein the fabric adhesive is a semi-permanent acrylic adhesive.

10. The anchoring device of claim 8, wherein the fabric adhesive is a repositionable adhesive.

11. The anchoring device of claim 8, wherein the skin adhesive is a medical grade, pressure-sensitive adhesive.
